(19) United States
(12) Patent Application Publication
(10) Pub. No.: US 2018/0183383 A1
(43) Pub. Date: Jun. 28, 2018

(54) Integrated Solar Photovoltaic Devices and Systems

(71) Applicant: Sandia Solar Technologies LLC, Pagosa Springs, CO (US)

(72) Inventor: Henry L. Lomasney, Pagosa Springs, CO (US)

(21) Appl. No.: 15/684,859

(22) Filed: Aug. 23, 2017

Related U.S. Application Data
(63) Continuation of application No. PCT/US16/18959, filed on Feb. 22, 2016.
(60) Provisional application No. 62/119,802, filed on Feb. 23, 2015.

(51) Int. Cl. H02S 20/26; H02S 40/30; H02S 40/42; E04C 2/52; E04C 2/284; E04D 3/35; E04D 3/40; E04D 13/17; E04F 13/074; E04F 13/077; E04F 13/075; B32B 7/12; B32B 3/30; B32B 5/20; B32B 27/06; B32B 27/08; B32B 27/42; B32B 27/20

(52) U.S. Cl. CPC H02S 20/26; H02S 40/32; H02S 40/425; E04C 2/526; E04C 2/523; E04C 2/284; E04D 3/352; E04D 3/357; E04D 3/40; E04D 13/172; E04F 13/074; E04F 13/077; E04F 13/075; B32B 7/12; B32B 3/30; B32B 5/20; B32B 27/065; B32B 27/08; B32B 27/42; B32B 27/20; H02S 40/30

(57) ABSTRACT

Solar PV devices are disclosed, wherein these devices are produced as an integral part of a structural panel. The structural panel may subsequently be used in any number of ways, including being made an integral part of a building structure such as a wall or a roof or another type of barrier structure, or simply a stand-alone array or even a retrofit addition to an existing structure. In embodiments, the panel comprises a semi-monocoque structure, which can provide strength and stiffness. The core of this semi-monocoque can provide an enclosure that functions to confine the solar PV's electrical system within an electrically insulating structure that provides dual insulation and may enables a dual-insulated rating. Embodiments of the panels disclosed herein also can provide cooling air flow to provide cooling to the panel.

### EXPRESS INCORPORATIONS BY REFERENCE

This application claims the benefit of priority to U.S. Provisional Patent Application No. 62/119,802 filed on Feb. 23, 2015, the entire contents of which are incorporated herein by reference. The entire contents, including the claimed subject matter and drawings, of each of U.S. Provisional Patent Application No. 61/801,772 filed on Mar. 15, 2013, U.S. application Ser. No. 14/218,840 filed on Mar. 18, 2014, and PCT Application No. PCT/US2014/031108 filed on Mar. 18, 2014, also are hereby expressly incorporated herein by reference.

### FIELD

This disclosure relates, among other things, to photovoltaic devices and systems, and methods for making them, as well as structural panels incorporating them.

### BRIEF SUMMARY OF CERTAIN EMBODIMENTS DISCLOSED HEREIN

Embodiments described herein provide self-contained photovoltaic (PV) devices and systems that can facilitate installation, by integrating the PV device into a structural building panel such as a Structural Insulated Panel or “SIP” panel to create an integrated, solar photovoltaic structural panel (“ISPSP”). Embodiments of the ISPSPs and systems disclosed herein advantageously employ a “dual insulation” design, which means that the individual electrical components are themselves each insulated, and the components are then contained in an insulated enclosure that provides an additional electrically insulating barrier around the electrical and electronic components. Embodiments of PV devices herein may meet the Class II electrical classification that is routinely related to electrical appliances.

In the case of a Class II or double insulated electrical appliance, the electrical system is designed in such a way that it does not require a safety connection to electrical earth ground. The basic requirement is that no single failure can result in dangerous voltage becoming exposed so that it might cause an electrical shock. This is achieved at least in part by having redundancy in the electrical insulation material surrounding live parts. Embodiments of this disclosure accomplish this by enclosing an insulated electrical components within an appropriately configured electrically insulating enclosure that is constructed of an electrically insulating medium, e.g., a Glass Fiber Reinforced Polymer (GFRP) structural medium.

Embodiments of the ISPSPs disclosed herein also include the positioning of various electrical components, e.g., components that provide an AC-PV system or DC-PV system within the ISPSP enclosure, including embodiments that provide a hermetic (i.e., airtight), substantially airtight, and/or waterproof or substantially waterproof seal for the electrical components and their electrical interconnection media. Parts of the enclosure may be electrically insulating and/or polymeric in nature.

Embodiments described herein provide relatively lightweight ISPSPs that are suitable for residential and commercial installations. Such embodiments can employ, for example, a semi-monocoque (SM) design as discussed herein. Embodiments of the ISPSPs, including those employing a SM design, can meet parameters of, e.g., UL 1703, which establishes for the solar PV system's structural integrity, bending and/or deflection limits.

Embodiments described herein also provide relatively lightweight ISPSPs that are designed to better withstand significant exterior temperature changes by providing a support for the PV absorber that provides some flexibility so as to mitigate the strain resulting from a coefficient of thermal expansion (CTE) mismatch within the fiberglass laminate structure. Such embodiments can reduce the stresses that can result from expansion and contraction of the components of the ISPSP with the change in temperatures during operation. Some embodiments of such devices can employ a GFRP laminate, whose design provides structural integrity during the device lifetime, as the supporting structure for the solar absorber of the device. Embodiments described herein provide ISPSPs that can reduce or minimize the heat exposure and the degradation experienced by solar cell, by means of a “chimney effect” cooling resulting from airflow within an internal air plenum. Such embodiments may employ a semi-monocoque structure wherein the core provides interior void spaces that permit convection of air through channels within the core wherein the air flow comes into contact with the thermally conductive GFRP skin which is in turn in thermal communication with the solar absorber cell. This conductivity and convective heat transfer provides a flow of warm air out of the channels and cooler air into the channels, further also enabling an optional recovery of the heated air for beneficial use. Embodiments described herein thus provide the introduction and exit of cooling air to be provided to the ISPSP while maintaining the weather-tight or substantially weather-tight properties of a roof structure.

Embodiments disclosed herein provide an embedded electrical system configuration that can be factory installed, tested and sealed such that the possibility of an installation error vis-à-vis the electrical system of the solar panel and arrays is minimized or substantially eliminated. Embodiments described herein also can include few or substantially no external metal parts associated with the ISPSP, thereby improving safety and reducing or eliminating the need for grounding circuits and the potential hazards associated with grounding faults. By eliminating the need for a grounding connection, embodiments described herein also can reduce or substantially eliminate the hazard of lightning strikes that can be associated with roof-mounted and ground-mounted solar arrays. Embodiments of the ISPSPs and systems disclosed herein also include the construction of a PV system and its structural semi-monocoque support panel in a manner that provides a waterproof (sealed), substantially waterproof, or functionally sealed, wall, roof, or other barrier structure, and wherein the electrical components and their electrical interconnection media are not exposed to weather degradation. Embodiments described herein provide a system for electrical connections that allow arrays comprised of multiple solar PV panels integrated into the ISPSP to be electrically interconnected using connectors that are designed for solar PV service. As noted above, embodiments herein provide the added advantage that the electronics systems can be installed and tested at the factory. Embodiments herein include the integration of functional testing of the fully installed and operational electrical system as an activity that is carried out as part of the ISPSP production sequence. Hence, embodiments of ISPSPs herein can be subjected to electrical performance testing and found to be working properly prior to installation.

As noted above, embodiments described herein provide ISPSPs comprising semi-monocoque structures that also function as electrically insulated building panels. Embodiments of such panels may possess sufficient structural integrity to withstand the normal operating conditions, e.g., wind and snow loads, that may be encountered with such systems. Embodiments described herein may include self-contained, solar photovoltaic power devices whose structural integrity is contributed by the host structure. This can be the building's structure, or a SM host to which the fiberglass laminate is attached. Embodiments of such SM structures can provide a stiff supporting structure for the solar absorber as well as an enclosure for electrical components that can conduct and manage electrical energy from the absorber as well as the thermal energy recovery. In embodiments, the enclosure comprises an electrically insulating material that provides an extra barrier of insulation for the electrical components. Embodiments of such devices further can pass the UL-1703 structural test criteria. The decreased weight of the solar PV system that results from such embodiments decrease the weight burden imposed upon the structure to which the PV device is attached.

Embodiments described herein provide ISPSPs, including those having a SM design, can provide operational advantages in terms of reliability. For example, embodiments of the ISPSPs described herein, including those incorporating a SM design, can reduce, substantially eliminate or eliminate one or more of the following: loose frames; defective absorber cells; glass breakage; J box and cable failure; power loss; and optical failures.

Embodiments of the ISPSPs and arrays disclosed herein are installed during the building construction process, wherein completion of the construction provides a concomitant installation of a solar PV system, in a cost-efficient manner. Alternatively, the ISPSPs can be installed in ground-mounted arrays. Embodiments of the solar PV system disclosed herein can eliminate or substantially reduce the need for racking, brackets or an auxiliary mounting system.

Embodiments disclosed herein thus can provide an ISPSP device with one or more advantageous features, including but not limited to the following:
An ISPSP comprising a SM structure is designed so as to include a lightweight solar PV support structure having appropriate specific strength and stiffness;
A ISPSP system containing electrical components for conducting and managing electrical power from the absorber such that the device may be installed and tested at the factory prior to the delivery of the device to the field for installation;
An ISPSP comprising a SM structure that incorporates GFRP into structural members such as a structural core, perimeter members and upper and/or lower layers to provide electrical insulation, specific strength and production advantages;
An ISPSP comprising a SM structure that comprises a GFRP as an upper layer to contribute to the SM's support for a solar absorber;
An ISPSP comprising a SM structure in which the structural components of the SM are adhesively bonded;
An ISPSP comprising a SM structure that comprises fire resistant, fire retardant or fireproof materials;
An ISPSP comprising a SM structure that comprises glass fiber reinforced phenolic resin to provide structural properties;
An ISPSP comprising a SM structure, wherein the GFRP composite provides thermal conductivity.
An ISPSP comprising a SM structure whose core comprises a structural foam that contributes the desired structural stiffness;
An ISPSP comprising a SM structure comprising a foam core that comprises channels, the internal geometric configuration of which contributes to providing the ISPSP with chimney effect cooling;
An ISPSP comprising a SM structure, comprising a ducted air cooling system in communication with a ventilation system such as a roof ridge ventilation system;
An ISPSP comprising a SM structure comprising a ducted air cooling system in communication with and augmented by roof peak ventilation;
An ISPSP comprising a SM structure, whose ventilation is augmented by a vent selected from wind turbine vents and gravity vents that are powered or gravity types.
A GFRP comprising glass fiber at a weight of from about 40% to about 70% by weight, and a polymer resin that provides the requisite physical properties;
An ISPSP comprising a SM structure and having a dual insulation design in which the electrical components of the device are contained in an electrically insulating enclosure within the ISPSP;
A, ISPSP comprising a SM structure constructed with structural members that reduce or eliminate the hazard of electrical shock due to contact with metal parts during installation;
A ISPSP comprising a SM structure in which some or all of the electrical components are encased in an electrically insulating potting compound;
A dual insulated ISPSP device that achieves a Class II-double insulated rating.
An ISPSP device that include inter-panel connectors that reduce or eliminate the hazard of electrical shock during construction of arrays of the ISPSPs.
An ISPSP comprising electrical connectors that provide reliable electrical connections;
An ISPSP comprising snap together connectors that provide improved electrical conduction properties; and
ISPSP devices that facilitate simplified installation.

### Definitions

The following definitions are used in this disclosure:

“Array” means an installation comprising two or more ISPSPs.

“Composite Building Material” is a building material made from two or more constituent materials with significantly different physical or chemical properties.

“Dual insulated” as used herein means double insulated. For example, in embodiments described herein, dual insulation is achieved by enclosing insulated electrical components within an electrically insulating enclosure that provides an additional insulation barrier for the electrical components.

“Structural Skin” this is the GFRP composite laminate that addresses the stress carrying function of a semi-monocoque. In this application the preferred composite is a glass fiber reinforced but there are alternatives such as carbon fiber composites, aramid fiber or cementitous skins. The key performance metric is the tensile and compression stress carrying capability.

“Shear Stress within a semi-monocoque” this may be calculated by idealizing the cross-section of the structure into a series of stringers carrying only axial loads and webs carrying shear flows. Dividing the shear flow by the thickness at a given portion of the semi-monocoque's structure yields shear stress. Accordingly, the maximum shear stress occurs in the realm of max shear flow or the minimum thickness. Therefore, an increase in core thickness will minimize the shear stress on the exterior skins.

“Semi-Monocoque ISPSP” or “SM ISPSP” is an ISPSP device comprising an SM structure.

“Chimney Effect Cooling” is the term used for a passive cooling phenomenon which is related to the drafting of air into and out of the chimney of a fireplace. The prediction equations for the thermal energy removed by a chimney per panel unit area is as follows: where Ic is in watts per meter 2. (see formula)

“Solar PV Stack” this term relates to the array of materials that serve to support, connect, and protect a solar cell during its operational lifetime. This includes adhesives encapsulants, and electrical bus-wires.

“Solar Thermal Energy” A portion of the energy spectrum which is provided by the sun's irradiance of earth. Most of this energy is provided by the infra-red waves of the solar spectrum.

“Grounding circuit” means a ground bond circuit that positively maintains safe voltages on the chassis of an electrical device. A grounding circuit helps prevent an electric shock resulting from an insulation failure.

“Pultrusion” means a process for manufacturing composites with a constant cross-sectional shape. The process consists of pulling a fiber reinforcing material through a resin impregnation bath and into a shaping die where the resin is subsequently cured. The result of the pultrusion process is referred to herein as a GFRP (Glass Fiber Reinforced Polymer). A “pultrusion” can sometimes also refer to the GFRP made using a pultrusion process.

“GFRP” means a composite of glass fiber and a binding polymer that has more than a nominal thickness, and is made from glass woven fabric that has structure and weave of the fabric such that, when combined with a polymer that imparts structural strength and stiffness.

“3D-GFRP” means a three-dimensional GFRP that has more than a nominal thickness, and is made from glass woven fabric that has structure and weave of the fabric such that, when combined with a polymer that imparts structural strength and stiffness, the glass fiber rises to its predesigned height due to the polymer's surface tension related interaction between the resin and the glass. The rising of the glass fibers may also result in the formation of mm scale, longitudinal channels that run the length of the 3D-GFRP.

“Dielectric withstand test” or “Hipot test” means herein a test designed to stress the insulation of a solar panel far beyond what it will encounter during normal use. The testing procedure is specified in UL-1703 or IEC 61730-2.

“Protective bonding/continuity test” means herein a test that is designed to test the resistance of the grounding circuit on a solar panel. The testing procedure is specified in UL-1703.

“Insulation Resistance Test” means herein measuring the total resistance of a product's insulation by application of a 500V DC or 1000 V AC. The testing procedure is specified in UL-1703.

“Semi-monocoque” as used herein refers to a load bearing support structure for the solar absorber that comprises a core and typically one or more exterior layers or “skin” elements, e.g., an upper layer on one side of the core that faces the solar absorber and a lower layer on the opposite side of the core, to deliver a desirable combination of weight, strength and stiffness.

“Inter-panel connector” or “IPC” as used herein means the electrical connecting member of a solar PV device that facilitates creating an electrical connection with an adjacent ISPSP device. Embodiments of the IPC may incorporate low electrical resistance connecting elements designed for disconnection under load, with minimal arcing degradation. The IPC may be an integral part of the structural panel's architecture and configured such that it automatically engages upon installation of the ISPSP, or it may be fitted to the SM as a pendant cable. In embodiments, the electrical interconnection becomes effective during field installation when electrical connection is effected between the IPCs of adjacent devices, e.g., by electrically connecting the devices. In dual insulated embodiments, the IPC will be designed consistent with the double insulated electrical features. The IPC can incorporate touch safe and hot plug features.

“Encapsulating Adhesive for Solar Absorber” is a polymeric material which is used to sandwich, suspend and support the solar absorber-semi-conductor layer within a medium which provides an adhesive bond to the structural support. In embodiments, this Encapsulating Adhesive is applied in a series of layers, which completely surround the absorber. It also may render the PV layer more resistant to stress and strain as a result of the strain management and stress distribution contribution within the composite system.

“Production Process Using Encapsulating Adhesive” as used herein this is a production process involving multiple layers of liquid polymer media which are mixed, delivered in a uniform manner, which then present a pre-gelled surface that receives the solar PV absorber cell layer using delivery techniques that reduce, substantially eliminate or eliminate the accumulation of entrained air at the polymer: cell interface. A secondary layer of encapsulation, which may be different, or the same or a modified version of the same encapsulation (or an appropriately modified version thereof) is subsequently applied. These encapsulants may be crosslinked to provide a durable, robust, highly transparent, and uv resistant continuum surrounding and affixing the solar PV absorber cell to the supporting structure.

### BRIEF DESCRIPTION OF THE FIGURES

The appended figures, briefly summarized below, are provided for exemplary understanding of this disclosure and do not limit this disclosure in any way. The dimensions provided in the figures are merely for illustration purposes and other dimensions may be used as desired and as appropriate.

FIG. 1a is a top view of an embodiment of a lightweight solar PV that is integrated into a semi-monocoque structural insulated panel.

FIG. 1b is a top view of an embodiment of a SM ISPSP showing the positioning of cooling channels within the core.

FIG. 1c is a top view of an embodiment of a SM ISPSP wherein air handling corridors are provided to extend air flow to the panel extremities.

FIG. 1d is a top view of an embodiment of a SM ISPSP that provides a recessed area for the electrical connections and electronics.

FIG. 2 illustrates an embodiment of a SM ISPSP that provides structural reinforcing detail at the corners of the perimeter GFRP rails.

FIG. 3 illustrates the embodiment of geometric corridors that contribute to cooling air movement within the SM structure.

FIGS. 4a and 4b illustrate embodiments of a SM ISPSP comprising cooling channels. In the case of 4a the channels are configured for mounting or securing the ISPSP in portrait orientation, whereas in FIG. 4b, they are configured for mounting or securing the ISPSP in landscape orientation.

FIG. 5a illustrates an embodiment illustrating one embodiment of attachment of the SM ISPSP a support structure.

FIG. 5b illustrates an embodiment that provides a means to provide a structural interconnection between two adjacent SM ISPSPs.

FIG. 6 illustrates an embodiment of the technique for installation of a SM ISPSP.

FIG. 7 illustrates embodiment of an installation technique for roof ridge attachment which provides an electrical raceway to host the electrical IPC.

FIG. 8a illustrates an embodiment of an IPC configuration wherein electrical cables are routed within a roof ridge.

FIG. 8b illustrates an embodiment using IPCs that function as electrical connectors such as “touch-safe” blind mate (self-aligning) electrical connectors.

FIG. 9 illustrates the use of roof vent system to augment the passive “chimney effect” cooling of the ISPSP.

FIG. 10 illustrates the use of an air mover to augment the passive cooling feature of the ISPSP.

FIG. 11 illustrates the solar PV absorption stack as it is integrally adhered to the semi-monocoque structural panel.

FIG. 12 provides a cross-sectional view of a SM ISPSP comprising cooling channel passageways.

### DETAILED DISCUSSION

### The GFRP and 3D-GFRP

Embodiments of the devices of this disclosure can be prepared using any number of materials, including but not limited to metals, non-metals such as glass-fiber, carbon fibers or other non-metallic materials, plastics, foams, polymers and polymer composites. In a number of embodiments disclosed herein, the device may comprise GFRP and 3D-GFRP polymer composites. Such composites can provide a number of advantages because they can be relatively lightweight, stiff, electrically insulating, corrosion-resistant and in some embodiments, fire-resistant.

As noted above, the GFRPs comprise glass fibers and polymer resin and can be prepared by the process of pultrusion. The glass fiber filled composite can utilize a number of binder polymers, including but not limited to, e.g., phenolic, epoxy, vinyl ester and polyester resins. Determining acceptable binder polymers for any particular PV device will take into account considerations such as, e.g., cost, CTE, processing characteristics, fire resistance, and rheological properties of the binder polymer.

3D-GFRPs are prepared from specially woven glass materials that expand to a predetermined geometrical orientation upon viscous liquid contact with the resin binder, and which upon cure of the said resin (or polymer binder), can form a flat, rigid member having a high level of specific stiffness and that may include interior channels. One example of a suitable 3D-GFRP composite material is Parabeam which is produced by the company PARABEAM, located at 5700 AC Helmond; the Netherlands. www.parabeam3d.com. Advantageously, a polymer binder is then applied to the Parabeam in order to achieve the required structural composite properties. Acceptable polymer binders include, for example, phenolic, vinyl ester, epoxy, and polyester. The phenolic resin is one good candidate due to its properties of low cost, high crosslink density, low CTE, high operating temperature and fire resistance.

One possible method for preparing the GFRP is to meter the resin addition, such that the ratio of glass fiber to resin is kept reasonably uniform and controlled throughout the composite. This resin impregnation process can be carried out on a substrate that will permit removal of the panel when the impregnation and curing process is completed. The production process can involve an appropriate curing cycle, and also can involve rolls of glass fiber media that facilitates a continuous production process.

As noted, the polymer and the filler additive media associated therewith advantageously can impart fire resistant or retardant properties, e.g., a phenolic thermosetting resin. Other resins that may be used include, e.g., epoxy, vinyl-ester, polyester and emulsified epoxy enhanced-portland cement resin blends. Criteria for selecting the resin for the GFRP include the production and processing protocol that is preferred, cost considerations, desired fire resistance and/or retardant properties, and structural properties such as CTE of the resulting GFRP. The glass fiber-to-polymer ratio can be controlled by employing appropriate process controls during the polymer impregnation process. As discussed below, the amount of glass loading may be tailored to achieve a desired structural stiffness property.

The Semi-Monocoque:

As discussed above, this can comprise a primary structural member within the ISPSP, as well as provide a support member for the solar PV system. The semi-monocoque typically comprises a core and one or more exterior layers or “skin” elements, e.g., an upper layer on one side of the core that faces the solar absorber and a lower layer on the opposite side of the core, that when combined can provide a support structure that has a good combination of weight, strength and stiffness. When experiencing downward loading from the solar absorber, the upper layer of the PV semi-monocoque is in compression and the lower layer is in tension. The core resists the shear loads and increases the stiffness by holding the upper and lower stress-carrying layers apart. In embodiments herein, the PV semi-monocoque provides a support for a solar absorber that is bonded directly to an upper layer on the PV semi-monocoque or indirectly through one or more layers interposed between the absorber and the PV semi-monocoque upper layer of the PV semi-monocoque.

### The SM ISPSP

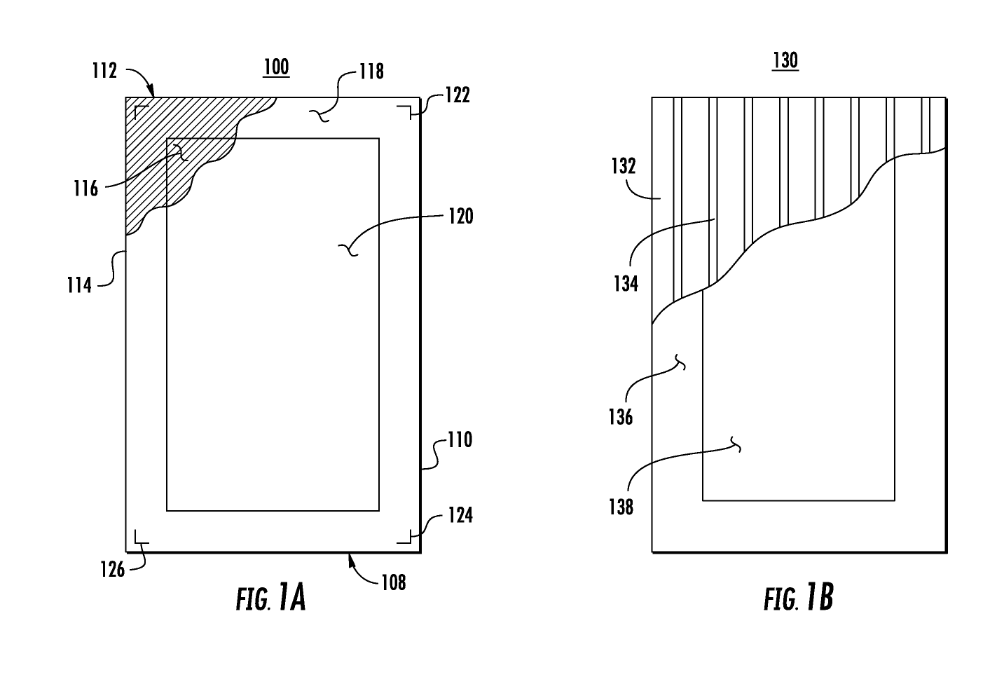

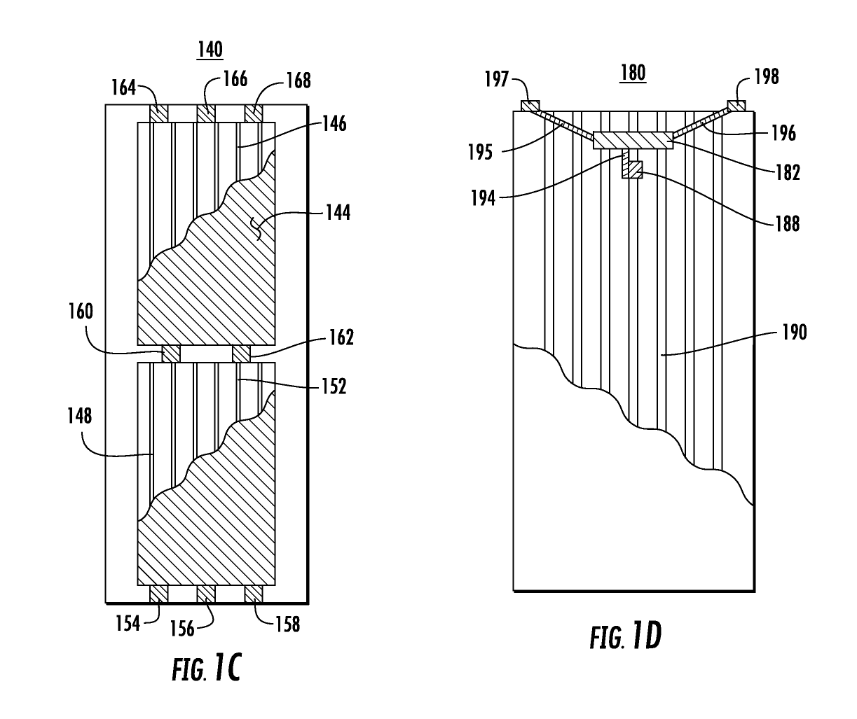

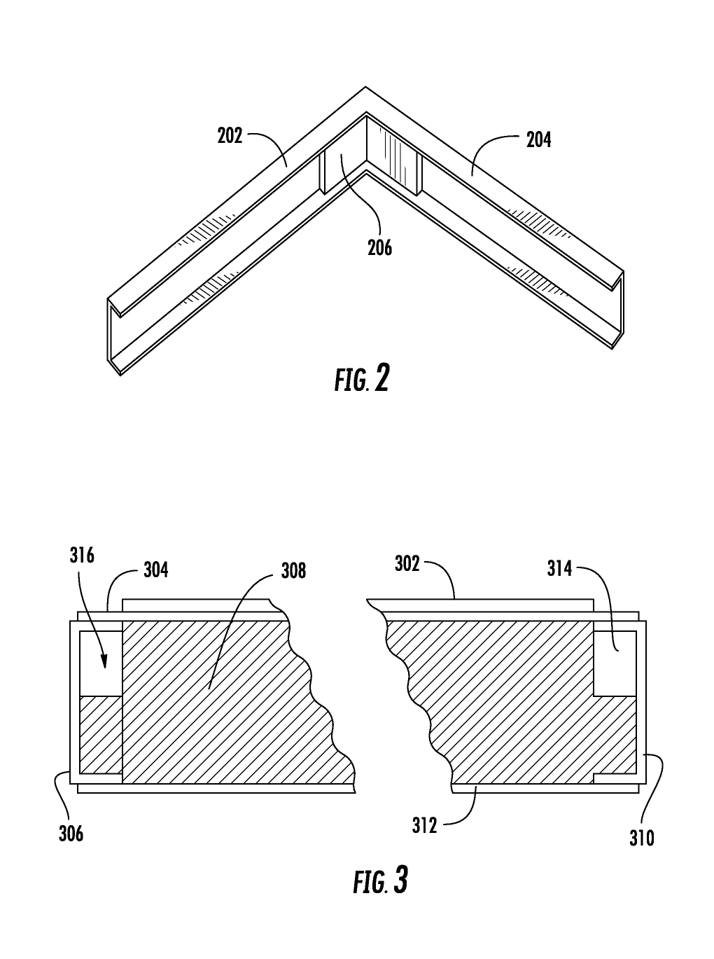

Embodiments of the SM ISPSP typically will consist of one or more internal support members and one or more perimeter members that define a continuous or discontinuous outer boundary of the semi-monocoque. Both the semi-monocoque structural panels and the solar absorber layers that are integrally incorporated thereto, are typically rectangular, and consequently, the perimeter members will typically define a continuous or discontinuous rectangular outer boundary of the semi-monocoque. In a SM design, the core element is the internal supporting structure which functions to maintain the appropriate spacing between the structural laminate skins, thus optimizing the strength to weight properties of the structure. When the perimeter members define four sides of the rectangle, e.g., as shown in FIGS. 1a-1c, they may be referred to as perimeter rails or simply as “rails”. Shapes other than rectangular are of course possible, and advantageous will permit tight fitting between adjacent SM ISPSP devices. Moreover, the SM ISPSP may be constructed to have separate internal members such as members that are shaped (e.g., “L” shaped, “C” shaped or tubular) such that they provide both the internal support and a desired contribution to the internal geometry of the core (e.g. a tubular member that is included for purpose of cooling air transport). Indeed, the core could even be fabricated as a single, integral member that provides the core's internal support structure.

The SM core's supporting geometry can be of any design, e.g., a chessboard-like design of crossing members, or any other design that accomplishes the goal of providing adequate support and stiffness for the device, as well as the thermal insulation, electrical enclosure and cooling air accommodation. Generally speaking, the core materials should help provide the desired strength and stiffness for the PV semi-monocoque. Any number of materials may be used in the core, including but not limited to organic foams, glass foams, hollow glass microsphere filled composites, or other non-metallic materials, plastics, inorganic foams, polymers and polymer composites. The GFRPs described herein can serve as the internal support members and/or the perimeter members, and can provide a number of appropriate properties because they can be readily shaped through pultrusion and are relatively lightweight, stiff, electrically insulating, corrosion-resistant and in some embodiments, fire-resistant.

Thereafter, in embodiments that employ upper and/or lower structural laminate stressed skin layers, the attachment of these layer(s) may be accomplished by mechanical fastening, application of a glass fiber filled resin coating layer using wet layup techniques, and/or adhesively bonding the laminate skin layers to the internal core support and perimeter members, at the contacting surfaces, which are typically presented by the faying surfaces of these members. In embodiments where GFRPs are used as core internal supports and/or as perimeter rail members and where the laminate stressed skin layer, and/or where a 3D-GFRP is used as one of the laminate stressed skins, the adhesive bond may be successfully achieved using a bonding agent, e.g., a two part-aliphatic epoxy polymer cured with a polyamidoamine curing agent. Such a material can be modified with a fumed silica to impart desired rheology, i.e., desirable thixotropic properties, and catalytic additives can be added to accelerate the cure. The adhesive can be packaged into premeasured cylinders that permit the two components to be simultaneously forced through a mixing tube, by means of an appropriately configured adhesive gun. Alternatively, where the production design calls for rapid curing, polyurea adhesives (that can be cured in short times such as seconds to minutes) can be employed. It also is possible to use prepreg tapes or structural tapes manufactured by firms such as 3M.

### Non-SM ISPSPs

Although the SM design of the ISPSP can provide certain advantages as discussed herein such that the incorporation of the SM structure in the ISPSP often will be the preferred structural design, it nevertheless is certainly possible to construct ISPSP's using other panel materials such as conventional SIPs that do not have a SM structures. For example, a PV solar absorber can be adhered onto the outer surface of a SIP to render the PV solar absorber integral with the SIP. Part or all of the electronics for conducting and managing electrical energy can be placed within the SIP or outside the SIP or partially in and partially outside of the SIP. Grounding circuits may be required depending on the particular SIP. Electrical insulation, air cooling channels, IPCs, electronics, and other features discussed herein also can be added into the SIP, using the disclosure herein as a guide as to desirable features Like SM ISPSPs, the non-SM ISPSPs may be assembled into arrays that form walls, roofs, barrier structures, stand-alone structures, or can be retro-fit to existing structures. In short, many of the techniques described herein for SM ISPSPs can be adapted to convert conventional SIPs into ISPSPs.

### Heat Management

The semi-monocoque structure can incorporate a mechanism or structural design whereby heat is transported from the back of the PV module and ducted through an arrangement of air transportation passages or corridor channels. As a result, the excess heat is managed in such a manner as to mitigate its adverse effect on the electrical output of the semiconductor and the electronics systems. As a result the operational lifetime of the PV system is extended and the energy conversion efficiency is improved. This transpirational cooling function can be achieved by the use of heat exchange using cooling air that is transported by natural convection or forced air transport or both.

### The Top and Bottom Structural Laminate Skin Layers

The underside of the semi-monocoque structure, i.e., the side not supporting the absorber, comprises a bottom layer that may partially or completely cover the bottom side of the monocoque. The lower layer must be able to carry the amount of stress necessary for delivering the desired strength to the PV semi-monocoque. This bottom layer may be made up of a single piece of material adhered to the underside. It may be applied using processing techniques that are well known in such industries as boat building. The bottom layer may have openings or gaps as appropriate to accommodate such functions as electrical connectors, structural attach features, and cooling air inlet and exit. Alternatively, the stressed element of the backing region may even be a part of the core's structure namely those regions that are placed in tension when the downward loading is imposed, which can contribute structurally to simplify and/or expand the design options for the structural laminate skin.

The uppermost stressed skin layer of the SM ISPSP can optionally be delivered to the system during the production sequence in a configuration wherein the solar PV absorber has been previously incorporated. This can be accomplished, e.g., by adhesive bonding of the lightweight solar PV absorber stack to a GFRP skin that provides added support to the solar PV stack which is superimposed thereon. This solar PV stack may include the solar absorber cells, the encapsulation adhesive sandwich/suspension media which bonds the absorber cells to the PV supporting GFRP layer and optionally a UV resisting layer which provides additional barrier properties, soil release, weather protection, including hail damage resistance for the system. For example, such a PV layer configuration can include the silicon solar cells, a crosslinking polymer, and a fluoropolymer layer such FEVE, ETFE and/or FEP.

In general the semi-monocoque's top structural laminate skin will be continuous so as to provide a weather tight and electrically non-conducting enclosure and generally will be made up of a single piece of structural skin material that is adhesive bonded to the perimeter railings and to the core. The upper layer must provide the appropriate structural stiffness that is appropriate for the solar PV device, and also sufficient stiffness to resist bending or deformation so as to deliver a structure with the appropriate structural integrity under the specified maximum load conditions that may be encountered in operation.

The upper and lower layers can comprise any material that meets the physical requirements of the semi-monocoque and PV device, e.g., glass fiber fabrics, carbon fibers, organic fibers and these fibers can be made into composites such as epoxy, phenolic, polyester, vinyl ester, and emulsified epoxy-portland cement blends, polyurethane and polyaspartics. The upper layer typically will comprise a laminate of materials that provide the requisite strength and stiffness. In embodiments, for example, the upper layer may comprise a GFRP. In another embodiment, the upper layer may comprise a 3D-GFRP. In other embodiments, the upper layer may comprise a 3D-GFRP and one or more layers interposed between the 3D-GFRP and the core. As another embodiment, the semi-monocoque may comprise an upper layer that is relatively thin combined with a 3D-GFRP or other stiff structural supporting laminate layer placed below the relatively thin layer. Advantageously, the design of the SM ISPSP will provide the structural integrity to reduce the possibility of cracking during the anticipated lifetime and the anticipated design load parameters including wind and snow loads. In yet other embodiments, the SM ISPSP can be produced as a core structure including skins that use thin phenolic skins and phenolic foam cores. In yet other embodiments, the core and upper and lower layer construction can be completed to the point that includes the installation of the electrical system and cooling system as well as the bonding of the topmost laminate skin layer and at that point, the solar PV can be introduced. This solar PV can be comprised of any one of a number of solar PV options. In embodiments, for example, the solar PV can be applied using liquid encapsulation materials.

Where upper and/or lower layers of materials are used, they may be fastened to the core, e.g., by a form of structural attachment such as a suitable adhesive bonding media or mechanical fasteners. Suitable adhesives include, e.g., rapid set epoxy adhesives, polyurea adhesives whose cure takes place in short times such as seconds to minutes, prepreg tapes and structural tapes, such as those manufactured by 3M Corporation, and thermoplastic adhesives. These can be applied using automated and robotic equipment. Electron beam, induction heating and uv curing can be used to deliver rapid curing.

### Inter-Panel Connectors (IPCs)

When constructing arrays of individual ISPSPs, it is necessary to electrically connect the individual panels. Embodiments described herein comprise connectors that are integral to the panels and which facilitate electrical connection of individual panels, i.e., inter-panel connectors (IPCs).

The IPCs permit two adjacent panels to be brought into electrical contact. In some embodiments, the IPCs may comprise a connector on each panel that is designed to physically mate with another to create an electrical connection. In other embodiments, the arrangement of these IPCs may comprise a pair, which are brought into proximity as part of the field installation. This pair may be subsequently joined by a third connector that functions as a jumper to electrically connect the IPC pair. In such cases, the third connector can be integral to the pre-installed panel or a separate, unattached connector that is added after the panels are placed adjacent to one another. In some embodiments, the IPCs are designed to abut or fit together such that if a panel requires service or malfunctions, then this panel can be disconnected from its adjacent panel(s) and removed without the need to disturb or detach adjacent panels. That is, the IPCs are in proximity to one another but do not physically overlap or otherwise significantly interfere with one another such that a single panel can be removed and replaced fairly easily.

Embodiments of the IPC may incorporate low electrical resistance connecting elements designed for disconnection under load, with minimal arcing degradation. In some embodiments, the IPCs may comprise electrical leads and contacts that are incorporated in the inter-panel connector design, and can optionally utilize contacts that are metallic or metal-plated (e.g., silver on copper) and body and stainless steel spring features that permit snap-fit connections. In such case, the stainless steel spring and wiping contact connector option can provide a secure- and reliable connection during the electrically loaded connecting or hot-plug disconnecting activities that can occur with solar panel installation and operation.

In embodiments, the IPC may be part of the ISPSP or may be attached to the ISPSP or other part of the panel. When used in conjunction with the dual insulated embodiments described herein, the IPC can be designed consistent with the double insulated electrical features. For example, the IPC can substantially comprise electrically insulating material such as a GFRP material into which are placed contacts that are not exposed externally, thereby decreasing the chance that an installer will come into contact with an electrically conducting metallic part.

Exemplary embodiments of IPCs are described below in connection with the figures.

### Electronics

Embodiments of the ISPSP devices described herein are designed to operate as an array comprising multiple panels that are connected by combinations of series or parallel circuits. As mentioned above, embodiments of the devices herein may be manufactured to include within the device some or all of the electrical components for conducting and managing the electrical energy coming from the solar absorber. The electrical components that are candidates for theses embodiments include but are not limited to wires, diodes, overcurrent protectors such as fuses, circuit breakers and surge protectors, busbars, micro-inverters, MPPT circuitry and circuitry for detecting whether the PV device is operating properly and/or malfunctioning. The PV devices also may include components and circuitry, including e.g., telecommunications or wifi technology, to tran PV/semi-monocoque it information concerning the operation of the PV device and/or malfunctions to a remote location where the information can be monitored.

Embodiments of such arrays can conduct electrical energy throughout the array as DC power, which DC power ultimately may be converted to AC by an inverter at a location near or remote from the array, and eventually to a local application (load) or alternatively to a power grid. Alternatively, embodiments of the ISPSP devices herein may include micro-inverters as part of the electronics of the individual ISPSP device, each panel thus providing AC electrical output.

In embodiments where a SM ISPSP is employed, the electrical components may be positioned within an enclosed area in the semi-monocoque structure, with wiring to an IPC or other connector external to the PV device (but internal to the SM) for communicating electrical power from the PV device. In such embodiments, it may be advantageous to provide a hermetic (i.e., airtight), substantially airtight, and/or waterproof or substantially waterproof seal for the electrical components and their electrical wiring. If the enclosure is constructed from electrically insulating materials such as GFRPs and 3D-GFRPs, then the enclosure can provide an additional electrical barrier, thus rendering the components in the enclosure doubly insulated. Parts of the enclosure may be electrically insulating and/or polymeric in nature. The electrical components also may be embedded in a potting compound. In such case, they may be within the enclosure or no enclosure may be employed.

For embodiments of ISPSPs in which electrical components have been included in the device itself, the ISPSP may be pre-tested following manufacture to determine whether the components and PV device are performing properly. Such performance testing prior to installation permits more efficient testing under factory conditions and reduces the shipment of malfunctioning panels. The testing regimen is designed in accordance with the appropriate end item acceptance testing that contributes to quality and reliability assurance of the device. For example, such testing methodology can be found in UL-1703. Examples of these tests include the Hi-Pot testing, continuity testing as well as the insulation resistance testing. Embodiments prepared according to this disclosure will meet one or more or all of such tests.

### The Solar Absorber and Associated Materials

The solar absorber may consist of any of the materials that are capable of converting sunlight into electricity. Examples are monocrystalline or amorphous silicon, CIGS, gallium arsenide, and cadmium telluride.

In some embodiments, the solar absorber may be covered with a tempered glass plate. In other embodiments, the absorber is covered with a suitable polymeric covering. Examples of polymers that can be employed for such purpose include fluorinated polymers such as ethylene tetrafluoroethylene copolymer (ETFE), fluorinated ethylene propylene (FEP), and polyvinylidene fluoride (PVDF). Such polymers provide extended lifetimes under ambient exposure conditions. These also exhibit light transmission property that exceeds the light transmission efficiency of glass by a few percent. These fluoropolymer films are characterized by their low surface energy, which may contribute to maintaining a cleaner surface. An alternative polymeric film for the exterior layer of the solar absorber is composed of a polycarbonate polymer (such as the polymer that is marketed under the commercial name of LEXAN).

Various processes may be used to provide a polymeric covering over the absorber including: applying the coating wet over the absorber followed by curing; adhering a preformed polymeric film layer over the absorber using an adhesive film: alternatively by heating a thermoplastic film such as acrylic that is placed over the absorber to cause it to adhere to the absorber in a manner that results in an airtight and watertight encapsulation.

In embodiments where the absorber is covered by a fluoropolymer film and supported by a GFRP, one process for securing the fluoropolymer film onto the glass fiber reinforced composite panel is accomplished using vacuum lamination. Laminator equipment for vacuum lamination may be divided by a flexible membrane into vacuum chambers, one chamber resting on a plate receives the stacked layers that will comprise the solar-cell system that includes the silicon wafers, the fluoropolymer film and the bonding and encapsulation films. The polymer film material which is preferably used for bonding and encapsulation is ethylene vinyl acetate (EVA). Initially, the plate temperature is kept below the softening point of this EVA. Next the two chambers are evacuated and the plate temperature is raised to the softening point of the encapsulating materials. Subsequently the upper chamber is ventilated and as a result, the flexible membrane is forced against the stack. In this way, a composite is formed comprising the solar cells and encapsulating materials. The encapsulating materials are hardened by further raising the temperature and thereafter the plate is cooled and the laminate is removed from the vacuum chamber.

In embodiments where a SM ISPSP is employed, the multilayered absorber media and its associated GFRP support layer, including the encapsulating materials, may then be affixed, (or adhered) to the topside of the core internal supports and perimeter members (if not already covered by a structural skin layer). This can be fastened mechanically or by application of an adhesive to some or all of the contacting surfaces of the core and GFRP. Alternatively, if the core has been previously covered with a structural skin layer, the GFRP may be adhered to the said covering layer by suitable adhesive or mechanical fasteners.

### Ambient, Non-Vacuum Production of a SM ISPSP

In embodiments, the semiconductor absorber medium can be sandwiched within an adhesive encapsulation medium whereby the said semiconductor system becomes more robust and thus more reliable as a functional medium for the anticipated service. This adhesive encapsulation medium can be designed to present the desired light transmission efficiency, the appropriate level of UV resistance, an optimized cure rate, to achieve an optimal production process, and the optimal level of hail damage protection to the absorber medium. In addition the adhesive encapsulation medium can be designed to provide an optimal thermal conductivity to the region between the absorber and the GFRP structure. The following illustrates one embodiment of a suitable production process:

STEP 1: After mixing of the two cross-linkable, thermosetting components, an adhesive encapsulation layer is applied to the stress carrying structural layer of the GFRP skin. The adhesive properties, toughness, lifetime performance and barrier properties of this adhesive encapsulation layer are designed as appropriate for this service and to provide the appropriate application and curing regimen that will satisfy the production protocol.

STEP 2: Prior to the advance of the crosslinking to a gelled state, the solar PV array is placed into this encapsulation adhesive of Step 1 in a manner that provides the occlusion of air and the associated elimination and mitigation of air bubble entrainment and which also permits its intimate bonding to the substrate

STEP 3: The bonding and encapsulation takes place under appropriate conditions of time temperature, confinement, and contact pressure to achieve appropriate process economics and product performance properties.

STEP 4: At an appropriate point where cure of the STEP 1 coating is sufficiently advanced. A second application of encapsulation coating is provided. Advantageously, this too is a conformal film that is free of bubbles and other undesired features. Suitable application methodology includes a process that utilizes a continuous, in line mixing procedure followed by a liquid coating deposition process, such as air spray. A subsequent application of a highly UV resistant coating layer is optional. This can be comprised of a fluoropolymer composition such as those that are well known for such service such as for example, FEVE or ETFE or FEP.

### Installing the SM ISPSP

It is well known that PV devices may be installed in a number of ways. The most popular involves a glass panel module which is mounted using a racking system that provides for connection of the device to the roof structure. Other methods include the adhesive bonding of a solar PV device to a flat roof with ancillary electrical system elements being secured by various means. In contrast to this prior methodology the embodiments described herein comprising a ISPSP device may form part of a barrier wall or roof, or may be affixed to a barrier wall or roof. The ISPSP may be adhered directly to the building's structure feature at the point when this feature is produced, e.g. in the factory and consequently, the installation of the ISPSP becomes an integral part of the assembly of the roof structure. The attachment can be made using an adhesive, or by mechanically fastening the structural panel to the roof supporting building structure. One example of a technique for achieving adhesive bonding is a “peel and stick” design. Alternatively, a ISPSP can be placed into service in a ground-mounted configuration using any suitable external structural support system.

When the ISPS is in place, the application of a liquid applied coating system can optionally be implemented to provide a continuous sealing medium. An example of such a coating system is a polyurea or polyaspartic material. Such systems provide impermeable, tough, durable, and weather resistant coatings. The application of such coating is proceeded by appropriate protection of the solar PV frontsheet using appropriate masking. Such coating application can contribute to snow release from the roof as well as aesthetic enhancements.

### DETAILED DISCUSSION OF THE FIGURES

Referring now to the figures, FIGS. 1 and 2 provide examples of various embodiments of SM ISPSPs that include various of the above-described features and elements.

FIG. 1a illustrates an embodiment wherein a solar PV system is integrated into a semi-monocoque structural panel to create a SM ISPSP (100) having GFRP perimeter rails (108), (110), (112), and (114). (116) is the sun facing structural skin layer of the SM. (118) is the SM's structural core. (120) is the “footprint” that will be filled by the affixed solar PV stack. (122), (124) and (126) are structural details made of GFRP that reinforce the corners of the perimeter rails. Although shown as separate components of this embodiment, the perimeter members also could be formed as one integral structure. As disclosed herein, the PV semi-monocoque (100) also may include an inter-panel electrical connector, structural feature(s), for mounting the device to a surface (all not shown). The wiring and electrical system (not shown) are contained within the glass fiber reinforced composite enclosure of this embodiment

Note also that the interior core can be comprised of a structural foam, or other materials that satisfy the objective of providing a semi-monocoque of sufficient structural integrity for the application, and advantageously one that passes the mechanical loading test criteria of UL-1703. Exemplary dimensions for the solar PV panel are as follows: 78 in. length and 40 in. width. The GFRP perimeter and support member may be configured, e.g., as “C” shaped members (see, e.g., FIG. 2).

Exemplary properties of the GFRP laminates and perimeter railings include the advantageous property that the polymer can impart fire resisting or retardant properties, e.g. a phenolic thermosetting resin. Other resins that may be used include, e.g. epoxy, vinyl-ester, polyester, epoxy-vinyl-ester. Criteria for selecting the resin include the production and processing protocol that is preferred, cost considerations, desired fire resistance and fire retardant properties, CTE and structural properties. The glass fiber to polymer ratio can be controlled by employing appropriate process controls during the infusion of polymer into the glass fiber matrix. The thickness of the laminate skin and the properties of the glass fiber matrix itself are controllable to modify the physical properties of the laminate structural skin.

Referring now to FIG. 1b, another example of a SM ISPSP (130) is provided. In the SM, the core provides cooling channels provides cooling channels, with (134) representing a typical channel. These cooling channels are of the appropriate geometry to provide the necessary cooling air flow within the solar PV system.

Perimeter structural members define the perimeter of the solar SM ISPSP. (132) represents one of such GFRP perimeter structural members. These members contribute to the GFRP dual insulated enclosure which houses the electronics (not shown) of the device. Upper layer (136) and lower layer (not shown) are made from GFRP and also serve to provide the GFRP dual insulated enclosure. In this embodiment, upper layer (136) of the SM provides the surface to which the solar PV device (138) is directly adhered. The cooling channels provide means for cooling air to contact the backside of the solar pv structure. The solar PV layer (138) is affixed to and placed in thermal contact with the GFRP skin layer (136), e.g., by bonding with adhesive having a good thermal conductivity. In this embodiment the lower structural laminate of the SM (not shown) covers the underside of the SM. This SM ISPSP may provide an electrically insulating enclosure for electrical components for conducting and managing electrical energy from the absorber, e.g., electrical wires, connectors, diodes, MPPT circuitry, and additional electronic features (not shown). There is no externally exposed wiring in this embodiment.

Exemplary dimensions for the SM ISPSP (130) are as follows: 78 in. length and 40 in. width. The GFRP perimeter and support member may be configured, e.g., as “C” shaped members.

In this embodiment, both the upper and lower layers are GFRP structural skins. These may be adhesively bonded to the internal core and perimeter structural members and the core structure, in which case connector clips or mechanical fasteners may become unnecessary. Adhesive options include the use of polyurethane or epoxy. A properly formulated adhesive can provide the desired bond strength to bond the upper and lower layers to the interior support and perimeter members. In this embodiment, a polyamidoamine cured epoxy that incorporates approximately five percent by weight of silica aerogel can provide an adhesive that has the desired structural bonding and rheological properties.

Referring now to FIG. 1c, another embodiment of a SM ISPSP (140) is exemplified. In this embodiment, two solar PV panels (144) and (150) are affixed. Cooling channels in the SM core are provided, as exemplified by (146) and (148). Cooling air passageways within the SM core (154), (156), (158), (160), (162), (164), (166), and (168) can move cooling air from the inlet region (e.g., near eave) to the exit region, typically higher in elevation (e.g., near roof ridge) so as to promote air movement.

A discussed above, the materials used in this embodiment, can be any material that provides strength and stiffness to the SM and advantageously which is electrically insulating, e.g., a GFRP. When the perimeter and upper and lower laminate skin layers are electrically insulating, then the enclosure will provide a second layer of insulation to the electrical components, thereby providing them a dual insulation feature.

FIG. 1d illustrates an embodiment of a SM ISPSP (180) in which the interior core is configured such that there is an interior geometry (182) wherein recessed spaces are provided to accept the electrical and electronic components. This can result in the electrical system that is dual insulated. For example, (182) can be a recessed region sized to accept an AC/PV micro-inverter. (188) is a recessed region within the core's geometry is sized to accept diodes, and/or MPPT electronics, or other such features. Alternatively, a single recessed region could be provided for all of the electronics. Grooves (194), (195) and (196) can accommodate the electrical wiring. Inter-panel electrical connectors (197) and (198) is where the wiring terminates. Cooling channels such as (190) are provided and intersect these recessed electrical and electronic features.

FIG. 2 illustrates an embodiment where the SM ISPSP is configured using a perimeter structural railing system made of a GFRP pultusion. This channel shaped pultrusion receives a structural detail that provides reinforcement of the corners. Perimeter member (202) and (204) are shown as “C” shaped members. They receive an angle shaped GFRP detail (206) that is adhesively bonded on both faces to the members 202 and 204.

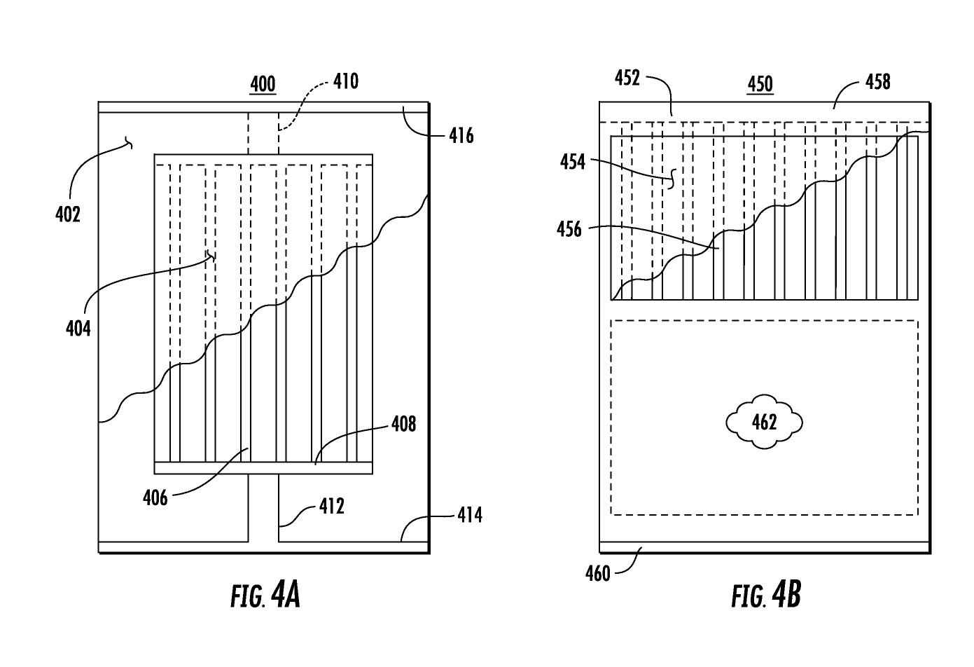

FIG. 3 illustrates an embodiment of a SM ISPSP with GFRP rails and foam core, which is configured to support the flow of cooling air supply to the channels beneath the solar PV. The solar PV stack (302) is bonded to the upper structural laminate skin layer of the SM (304). Advantageously, these stressed skin layers (304) and (312) impart strength and stiffness to the SM. The SM's core consists of perimeter channel pultrusions (306) and (310). The foam core (308) occupies most of the space between the stressed skin layers, while providing sufficient unoccupied corridor regions (314) and 316 to provide the cooling air passageways that are necessary for appropriate cooling air feeds, while maintaining the appropriate structural stiffness. The corridors (314) and (316) function as supply and exit manifolds that interact with the solar PV's cooling by a “chimney effect” that can contribute to heat dissipation thereby cooling the solar panel by cooling the supporting structure. At the same time, this cooling air flows over and around the embedded electrical system components.

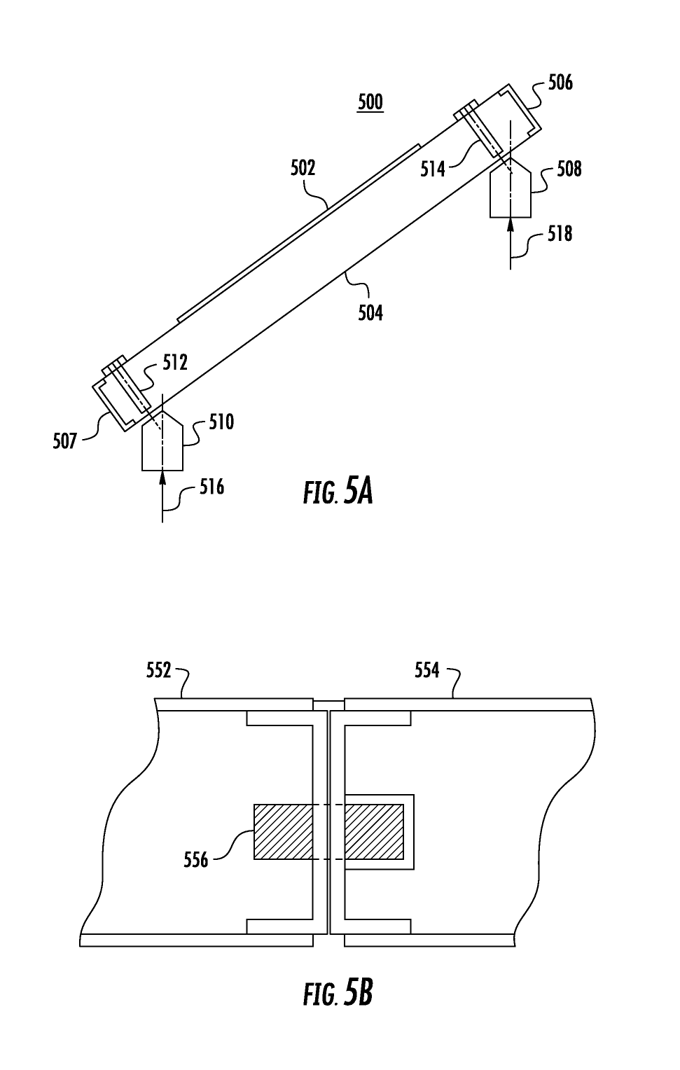

FIG. 4a illustrates an embodiment where a SM ISPSP's cooling channels are directionally oriented such that the solar PV module is positioned in the portrait direction. (402) represents exterior surface of semi-monocoque's sunlight facing GFRP skin. (404) illustrates the exterior surface of the solar PV stack. A cut-away view of the cooling air channels e.g., (406) that remove the heat as a result of the cooling air contact with the backside of the solar PV stack. (408) illustrates the manifold regions of the cooling air communication corridors. (410) and (416) which are indicated herein as they lay beneath the structural skin laminate (402). These corridors function to provide the cooling air communication corridors which serve to provide air movement from the inlet regions to the exit region. These channels and corridors are of appropriate depth into the foam core and beneath the surface laminate skin layer, such that they provide the requisite balance of air flow volume and structural stiffness without and undue sacrifice in the insulation property of the ISPSP.

FIG. 4b illustrates an embodiment where a pair of SM ISPSP's cooling channels are directionally oriented such that the solar PV module is positioned in the landscape direction. (452) is the exterior surface of the solar PV semi-monocoque SIP. (454) is the exterior surface of the solar PV stack. Colling air channels, illustrated by (456), serve to remove heat from the backside of the solar PV stack. (458) (hidden from view) are the air conducting corridors, denoted by (458), are located adjacent to perimeter rail in proximity to the air exit (e.g., near roof ridge). The air conducting manifold corridor (460) is located adjacent to the perimeter rail and functions as the air inlet, which may optionally be supplied by the exit air from an adjacent module or alternatively from an appropriate opening in the bottom skin layer (462).

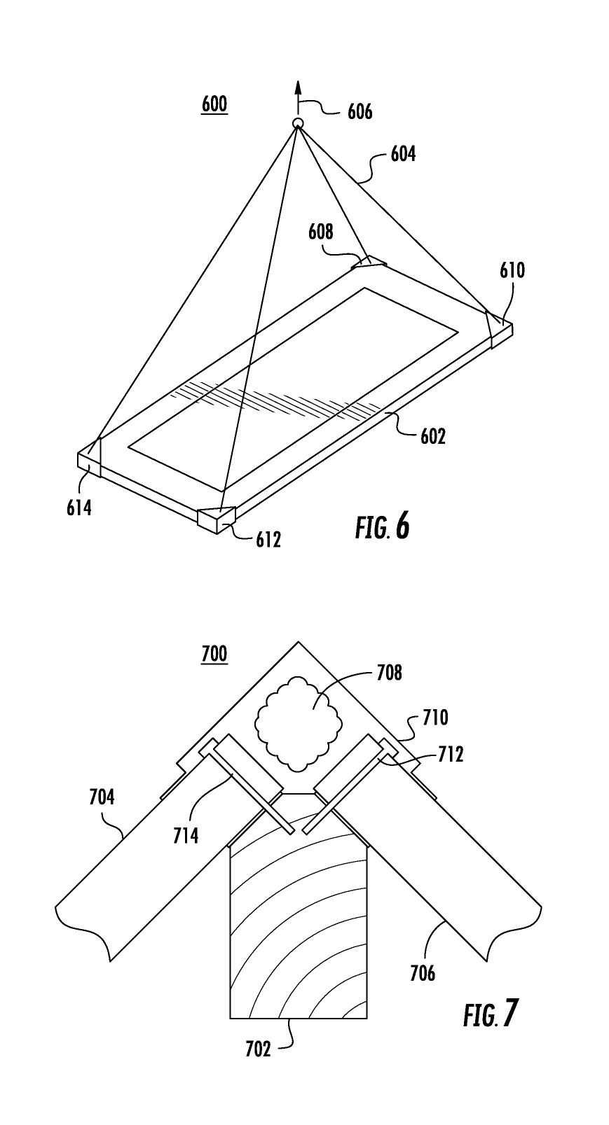

FIG. 5a illustrates embodiment of SM ISPSP devices that are configured for roof mounting using an appropriate support structure (here represented as column supported beams). (502) is the SM ISPSP. Perimeter railings (504), (506), and (507) are made of GFRP pultruded channels. Supporting structures (508) and (510) are shown. Suitable structural fasteners (512) and (514) are provided, as well as suitable vertical supporting members (516) and (518).

FIG. 5b illustrates an embodiment of SM ISPSP devices that are configured for roof mounting wherein an interconnection is provided between adjacent SM ISPSPs (552) and (554). (556) is a structural member that both connects the two panels together but also helps maintain alignment, which can deter undesired inter-panel movement that could present in-service difficulties.

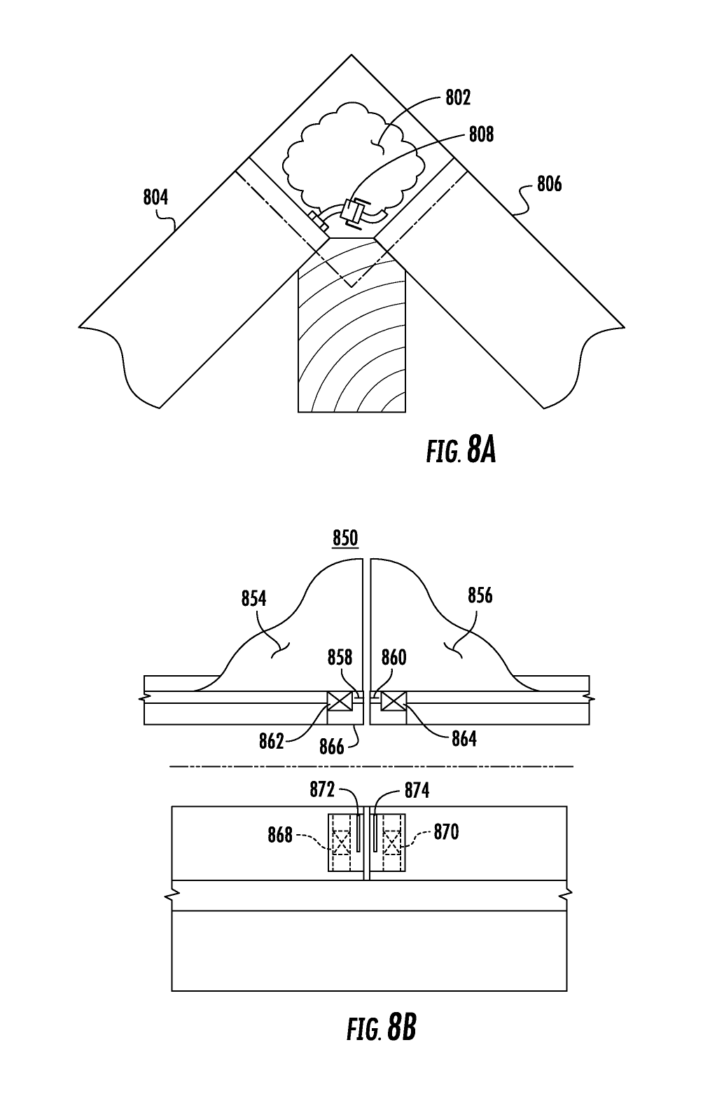

FIG. 6 illustrates an embodiment related to the installation methodology of a SM ISPSP wherein (602) is the SM ISPSP device as it is suspended for installation. (604) is a supporting sling of appropriate configuration. (608), (610), (612), and (614) are attachment interface and engagement features that provide the points of attachment to handle the structural panel during its installation. (600) represents a suitable hoisting mechanism.

FIG. 7 illustrates an embodiment that provides a roof ridge enclosure for an array of SM ISPSPs as they interface with an adjoining array of panels, which may be SM ISPSPs or non-solar SIPs, which may or may not have an SM structure. (702) is a supporting structure and (704) is a SM ISPSP (facing the sun). (706) is a corresponding non-solar panel that is facing away from the sun. (708) is the unoccupied void geometric cavity void that provides a cooling air and electrical service cavity. (710) is a weather tight ridge flashing feature. (712) and (714) are appropriate fasteners.

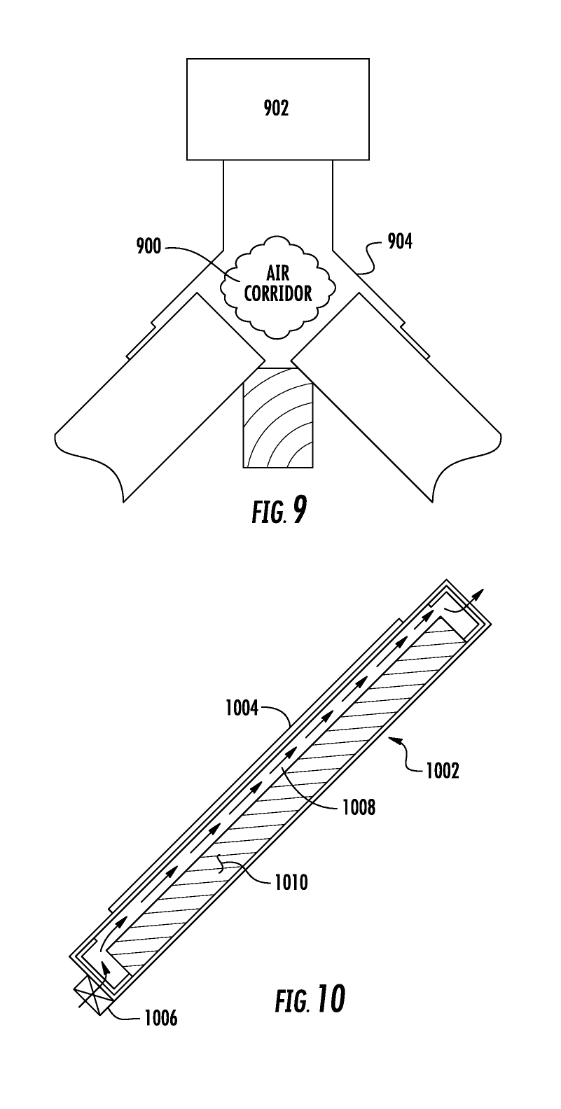

FIG. 8a illustrates an embodiment that provides an electrical inter-panel connector (IPC) feature that is located within the roof ridge enclosure. (802) is the usable void geometry that can accommodate the cooling air flow as well as providing a cavity for the electrical service. (804) is the sunlight facing solar PV semi-monocoque SIP and (806) is an adjacent panel (e.g., a SM SIP) facing away from the sun. (808) is an electrical cable and connector that is suitable for solar service—having “touch-safe” and “hot-plug” capabilities.

FIG. 8b illustrates an embodiment using IPCs that function as electrical connectors such as “touch-safe” blind mate (self-aligning) electrical connectors. (850) illustrates the electrical interconnection medium between two adjacent ISPSP systems. (854) and (856) are sunlight-facing solar PV absorber panels, wherein adjacent touch-safe electrical connectors (862) and (864) are shown in elevation view. These are mounted within an electrically insulating GFRP enclosure (866). (858) and (860) are the connector ends of an electrical current carrying connector. (872) and (874) are the same connectors as (858) and (860) shown in plan view. (868) and (870) are the touch safe blind connectors shown in plan view.

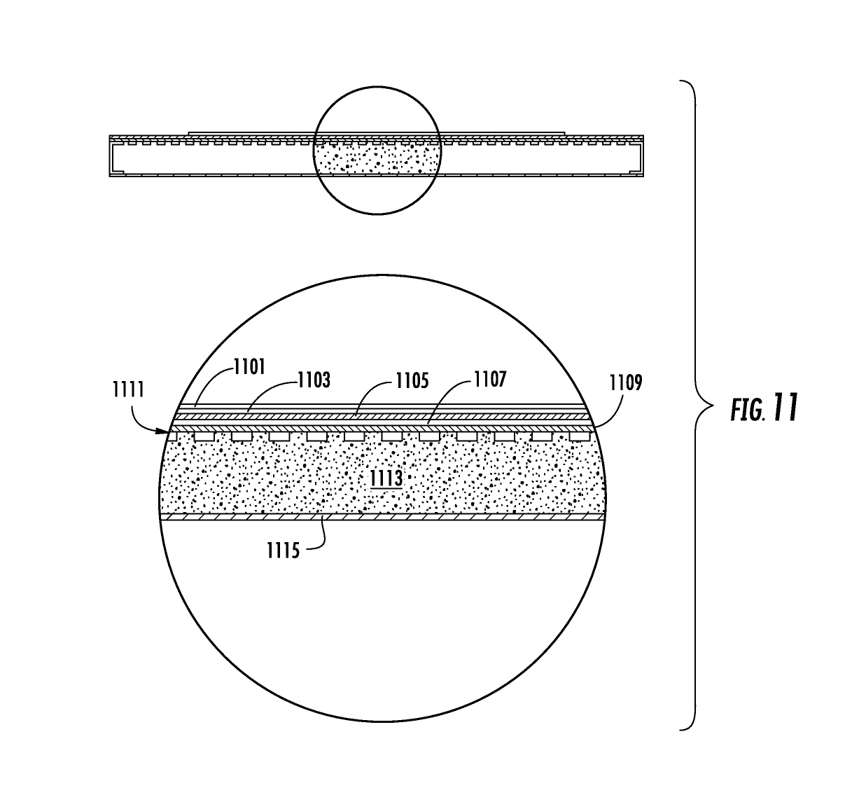

FIG. 9 illustrates an embodiment that provides a ridge ventilation feature. (902) is a ventilation feature designed such that it provides the removal of warm air from the air corridor enclosure (900) that is provided to the air corridor by the thermal transport enabled by the SM ISPSP's chimney effect. (904) is a suitable covering/attachment to the adjacent enclosed space.

FIG. 10 is an embodiment which provides cooling air flow augmentation by means of an air mover. (1002) is a SM ISPSP and (1004) is the solar PV feature that is affixed thereto. (1006) is an air mover that is an appendage to the panel. (1008) is cooling air flow within the channels that are contained within the SM core (e.g., foam core). 1010 is the foam core of the SM.

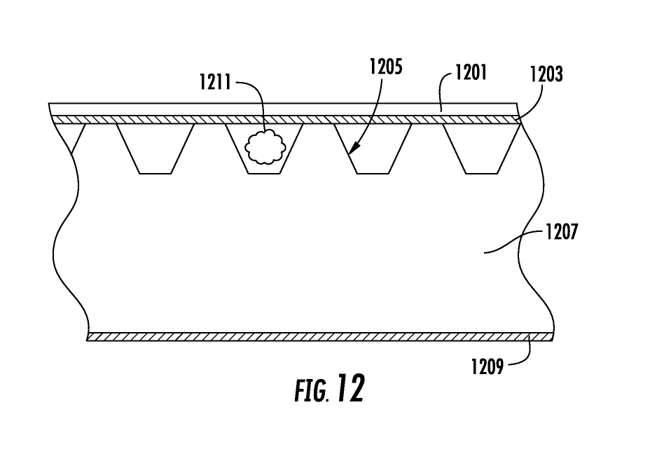

FIG. 11—provides an enlargement of a portion of a SM ISPSP and illustrates an embodiment for producing the panel devices using multiple layers of crosslinking polymer media. (1101) is an optional layer of a transparent, protective, and UV resistant polymer layer that is adhered to the encapsulating adhesive layer polymer layer (1103). Layer (1101) can be any suitable adhesive, e.g., transparent polyurethane, polyvinyl fluoride. polyvinylidene fluoride, polycarbonate, polyaspartic, and/or fluoropolymer, such as FEVE, EFVE, ETFE or FEP. Advantageously, this transparent material should provide a high level of light transmission, resistance to degradation during an extended lifetime, and can optionally resist soil buildup when exposed to atmospheric elements. (1103) is the encapsulating adhesive polymer layer, which may be selected from any suitable polymer, e.g., polyurethane, polyvinyl fluoride, polyvinylidene fluoride, polycarbonate, polyaspartic, fluoropolymer, aliphatic epoxy, polyurea, and vinyl ester. (1105) is a layer of photovoltaic absorber materials that is secured in place by the adhesive and encapsulation layer (1103), which in turn provides the attachment medium that communicates with the GFRP structural composite that provides the sunlight facing structural skin layer of the semi-monocoque structure. This encapsulating adhesive polymer (1107), optionally having enhanced thermal conductivity, is located between the underside interface of the solar PV absorber (1105) and its supporting lightweight GFRP layer (1111) structural skin layer of the semi-monocoque.

In a subsequent stage of production, this assembly may be subsequently bonded to the semi-monocoque. Preferred materials for this layer (1109) include any appropriate structural material that can provide the stress carrying features needed for this service. One acceptable material for this layer is a glass fiber reinforced polymer composite (GFRP), e.g., wherein the glass fiber loading to polymer is in range of 1:2 to 2:1 by weight, including between 1:1.5 to 1.5:1, 1:1.25 to 1.25:1, and about 1:1, and the polymer may be any suitable polymer, e.g., a phenolic. An alternative composition can result in a composite that provides a high thermal conductivity feature which enhances the cooling function of this system. The composition can optionally include a composite wherein the fire resistance is enhanced with filler media. This structural composite can comprise, e.g., an emulsified thermoset resin system wherein a hydrate forming filler media—such as Portland cement is provided. Such a composition being used to provide the polymeric feature to the GFRP wherein such a composite contributes a desired combination of physical properties to the semi-monocoque structure.

The upper GFRP stressed skin of the semi-monocoque (1111), the semi-monocoque's core (1113), and the lower GFRP stressed skin of the semi-monocoque (1115) all can contribute to the structural rigidity of the semi-monocoque, wherein 1111 is connected by an adhesive layer that bonds the upper and lower regions of the structural system. When thus bonded, the features of the SM ISPSP and the rigidity imparted by the semi-monocoque structure, including its embedded and integral electrical and cooling features, become integral in the panel. The core of the semi-monocoque (1113) can be, e.g., a foamed structure whose physical properties are selected to deliver the appropriate structural features, including strength and stiffness. Alternative core structures include any alternative material that can provide the necessary physical properties to the semi-monocoque design. The core design and geometry can be configured (e.g., as shown) to provide for cooling as well space for containing the embedded electrical system components. (1115) is the lower facing stressed skin laminate structural layer of the semi-monocoque. Suitable materials for this layer can include a GFRP stressed skin or any appropriate structural material that can provide the stress carrying features needed for this service. Advantageously, (1115) provides electrical insulation. The composition can be similar to that of layer (1109) or (1011) or it can be different. One acceptable material for this layer is a glass fiber reinforced polymer composite (GFRP) as described above for 1109, e.g., wherein the glass fiber loading to polymer is in range of 1:2 to 2:1 by weight, including between 1:1.5 to 1.5:1, 1:1.25 to 1.25:1, and about 1:1, and the polymer may be any suitable polymer, e.g., a phenolic. Alternatively the composition of this layer can be of a lighter weight and thinner composite as compared to the stress carrying upper layer.

It is noted that the application of the bonding and encapsulation materials of FIG. 11 can be carried out using any appropriate means that can provide the desired coatings, for example, liquid precursor compositions that are premixed and then applied in liquid form using application techniques such as airless spray, conventional spray, air assisted application. It is also noted that these materials can be thermoset or thermoplastic and they can be delivered as sheet media or pre-prepared films when such is preferred.

FIG. 12 illustrates an embodiment which permits use and/or management of solar thermal (heat) from SM ISPSP. This is provided by the introduction of a corrugated medium (1205) to the core region. Optionally, e.g., a foam core can be provided by a foam-in-place system (such as two component polyurethane). In such case, the polyurethane foam will conform to the internal geometry and it will provide a bond thereto. The result is a beneficial contribution to the thermal insulation if this structural panel and as well as benefits to the structure of the semi-monocoque as well as to the economics of the production process. (1203) is the GFRP stressed skin upper laminate. (1205) is a preformed corrugated medium whose geometry will provide the appropriate channel geometry within its cross-section and whose composition is appropriate for heat transfer from the solar absorber region into the cooling air confined therein. (1207) is a core, e.g., a foam-in place urethane. (1209) is the GFRP stressed skin lower laminate, and (1211) represents the cooling air passageways of cross section selected for the panel.

### EXAMPLES

The following non-limiting examples are provided to further illustrate certain identified embodiments described herein and are not intended in any way to limit the scope of the inventions defined in the appended claims.

### Example 1

### The Following Represents One Possible Process for Making SM ISPSP Devices.

Devices can be made using a design similar to that described in FIG. 1a. The envelope dimensions of these panels can be: 48 inches in width and 192 inches in length (i.e. 4 feet by 16 feet=64 square feet) and each of these panels can be fitted with two solar PV systems having 72 silicon solar cells on each. A pair of these panels can be fabricated. Each panel can utilize a perimeter railing that has a structural GFRP channel pultrusion of 4 inch high by ¼ inch wide by ¼ inch wall thickness (weighing 1.12 pounds per foot). The foam core can be 1.5 pound density expanded polystyrene. This foam core can be designed to fill the interior space of the semi-monocoque structure whose geometry is defined by the perimeter railing system.

A sunlight facing structural skin layer can be a phenolic GFRP laminate (of thickness-0.055 inches) and tensile strength 37,000 psi, This top skin laminate layer of the four foot wide by 16 feet long GFRP (i.e. 64 square foot solar PV semi-monocoque SIP) will weigh approximately 16 pounds. The foam core can be machined to provide the cooling air channels in the regions that are contacted by the solar PV system as well as the air transport corridors that supply air to these channels. The machining of the core also can include the provision of cavities to receive the electrical and electronic components. (After the machining operation, the foam core can weighs 28 pounds). The bottom facing structural skin layer can be a phenolic GFRP laminate (of thickness 0.028 and tensile strength of 42,000 psi). This 64 square foot structural skin element can weigh approximately 27 pounds.

The bottom skin can be first bonded to the perimeter railing using a polyamidoamine cured epoxy adhesive. A cure time can be overnight at 75 degrees F. Next, the pre machined polystyrene foam core can be installed and bonded to the bottom skin. At this point, the bottom half of the solar PV semi-monocoque SIP would be ready for the installation of the electrical and electronic package. Next, two solar PV modules can be fabricated using GFRP structural support panels having envelope dimensions of 40 inches by 78 inches and thickness of 0.028 inches thickness. Each of these can weigh approximately 5.5 pounds prior to adding the PV stack. This PV stack can be produced using the following vacuum lamination process:

This solar absorber stack can comprise a top-most film layer of fluoropolymer film, below which is an EVA layer, below which is a silicon solar cell, below which is another EVA layer. The prototype can consist of a solar PV device that incorporates 72 solar cells bonded to a 40.0 inch by 80.0 inch GFRP skin described above. The vacuum lamination process can involve a vacuum regime of approximately 50 mm Hg at room temperature for 5 minutes followed by a thermal regime of increasing temperature to a maximum of 300 degrees F.—over a duration of 15 minutes. The weight contribution from the solar stack so prepared can be about 12.2 pounds. The nameplate power rating of these solar PV semi-monocoque prototypes can be 670 watts.

The pair then can be readied for assembly onto a support structure where it will be positioned as appropriate for testing. The assembly onto the test stand can follow the methodology described herein. This will include the application of a protective and weather resistant polyurea coating system. This coating can assure the protective integrity of the roof structure.

This testing would involve instrumentation that will characterize the performance of the cooling system, the structural behavior of the SM ISPSP, and the operational reliability of the solar PV power production system.

### Example 2

### The Following Represents Another Possible Design of a SM ISPSP:

Using the design similar to that described in the FIG. 10, the envelope dimensions of these panels can be: 48 inches in width and 192 inches in length (i.e. 4 feet by 16 feet=64 square feet) and each of these panels can be fitted with two solar PV systems having 72 silicon solar cells on each. A pair of these panels can be fabricated. Each prototype can utilize a perimeter railing that has a structural GFRP channel pultrusion of 4 inch high by ¼ inch wide by ¼ inch wall thickness (weighing approximately 1.12 pounds per foot). A corrugated channel medium can be adhesively bonded to the upper laminate GFRP layer using an adhesive material that features a high thermal conductivity. The electrical and electronics system can then be installed and the lower laminate GFRP layer can be bonded in place using an epoxy/polyamidoamine adhesive. Next, a foam-in-place polyurethane material can be injected in such a manner as to fill the appropriate spaces, thus forming the core of the semi-monocoque. The resulting foam core can have approximately 1.5 pounds per cubic foot density. This foam core can be designed to expand in such a manner that it fills the interior space of the semi-monocoque structure during this expansion if the semi-monocoque's external envelope is sufficiently constrained such that its dimensions are not unduly distorted.

A sunlight facing structural skin layer can be a phenolic GFRP laminate (of thickness-0.055 inches) and tensile strength is in range of 37,000 psi. This top skin laminate layer of the four foot wide by 16 feet long GFRP (i.e. 64 square foot solar PV semi-monocoque SIP) could weigh approximately 16 pounds. The bottom facing structural skin layer can be a phenolic GFRP laminate (of thickness 0.028 and tensile strength of 42,000 psi). This 64 square foot structural skin element can weigh about 27 pounds.

Prior to the installation of the corrugated channel medium, the electrical/electronic system and the foam-in-place operation, the bottom skin can first be bonded to the perimeter railing using a polyamidoamine cured epoxy adhesive. The cure time for this adhesive can be overnight at 75 degrees F.

When this is completed, the lower part of the SM ISPSP would be ready for the installation of the corrugated channel medium and the electrical and electronic package, and the GFRP enclosure is then ready for the foam-in-place urethane.

In a corollary production activity, two solar PV modules can be fabricated using lightweight GFRP structural support panels having envelope dimensions of 40 inches by 78 inches and thickness of approximately 0.028 inches thickness. Each of these can weigh about 5.5 pounds prior to introducing the encapsulating polymer layers and the corresponding solar absorber material layers, which can add about another seven pounds to the weight of the PV device. The weight contribution from the above described solar stack can be about 12.5 pounds. The nameplate power rating of the above described solar PV semi-monocoque prototypes can be about 670 watts.

Embodiments of this disclosure thus include, but are not limited to, the following:
1. An integrated, solar photovoltaic structural panel, comprising:
   a panel comprising top and bottom stressed skin layers and a support there between that provides separation of the top and bottom layers, and
   a solar photovoltaic system that is integral with the panel, wherein the solar photovoltaic system comprises:
   a solar absorber affixed to the top layer of the panel; and
   electrical components for conducting and managing electrical energy, wherein the electrical components are contained between the top and bottom layers.
2. An integrated, solar photovoltaic structural panel, comprising:
   a semi-monocoque comprising a core and top and bottom layers, wherein the core comprises a support that carries shear loads and provides separation of the top and bottom structural layers, and
   a solar photovoltaic system that is integral with the semi-monocoque, wherein the solar photovoltaic system comprises:
   a solar absorber affixed to the top structural layer of the semi-monocoque; and
   electrical components for conducting and managing electrical energy, wherein the electrical components are contained within the semi-monocoque, and
   wherein said semi-monocoque is adapted to form a part of an exterior barrier of a building structure.
3. An integrated, solar photovoltaic structural panel according to embodiment 1 or 2, wherein said panel is adapted to form part of a wall or a roof of a building structure.
4. An integrated, solar photovoltaic structural panel according to any of embodiments 1-3, comprising an adhesive encapsulating layer wherein the solar absorber is embedded.
5. An integrated, solar photovoltaic structural panel according to any of embodiments 1-4, comprising a liquid-applied, adhesive encapsulating continuum enclosing the solar absorber.
6. An integrated, solar photovoltaic structural panel according to any of embodiments 1-5, comprising a UV protective layer covering the solar absorber.
7. An integrated, solar photovoltaic structural panel according to any of embodiments 1-6, comprising a UV protective fluoropolymer layer covering the solar absorber.
8. An integrated, solar photovoltaic structural panel according to any of embodiments 1-7, comprising a thermosetting adhesive layer between the top layer and the solar absorber, wherein the thermosetting adhesive layer bonds the solar absorber to the top layer.
9. An integrated, solar photovoltaic structural panel according to any of embodiments 1-8, comprising a thermosetting adhesive layer between the top layer and the solar absorber, wherein the thermosetting adhesive layer bonds the solar absorber to the top layer, and wherein the thermosetting adhesive is thermally conductive.
10. An integrated, solar photovoltaic structural panel according to embodiment 9, wherein the thermosetting adhesive comprises a thermally conducting additive.
11. An integrated, solar photovoltaic structural panel according to embodiment 10, wherein the thermally conducting additive is selected from the group consisting of alumina, boron nitride, zinc sulfide, exfoliated graphite, di-iron phosphide, and combinations thereof.
12. An integrated, solar photovoltaic structural panel according to any of embodiments 1-11, wherein the top layer is a glass fiber reinforced polymer (GFRP).
13. An integrated, solar photovoltaic structural panel according to any of embodiments 1-12, wherein the GFRP comprises a thermally conducting additive.
14. An integrated, solar photovoltaic structural panel according to embodiment 13, wherein the thermally conducting additive in the GFRP is selected from the group consisting of alumina, boron nitride, zinc sulfide, exfoliated graphite, di-iron phosphide, and combinations thereof.
15. An integrated, solar photovoltaic structural panel according to any of embodiments 1-14, wherein the structural core comprises a foam.
16. An integrated, solar photovoltaic structural panel according to any of embodiments 1-15, wherein the panel comprises channels adapted to provide airflow within the panel.
17. An integrated, solar photovoltaic structural panel according to embodiment 16, wherein the channels are adapted to provide a chimney effect to provide passive cooling to the panel.
18. An integrated, solar photovoltaic structural system according to any of embodiments 1-17, wherein the structural foam core includes at least one cavity and wherein electrical components are contained within the at least one cavity.
19. An integrated, solar photovoltaic structural panel according to any of embodiments 1-18, wherein the panel comprises channels adapted to provide airflow within the panel, and wherein the airflow provides cooling to at least one electrical component within the panel.
20. An integrated, solar photovoltaic structural panel according to any of embodiments 1-19, wherein the panel electrically insulates at least one electrical component within the panel.
21. An integrated, solar photovoltaic structural panel according to any of embodiments 1-20, wherein all electrical components within the panel are electrically insulated by at least one layer of electrically insulated material.
22. An integrated, solar photovoltaic structural panel according to any of embodiments 1-21, wherein all electrical components within the panel are electrically insulated by two layers of insulating material.
23. An integrated, solar photovoltaic structural panel according to any of embodiments 1-22, wherein the bottom layer is a GFRP.
24. An integrated, solar photovoltaic structural panel according to any of embodiments 1-23, further comprising at least one perimeter member.
25. An integrated, solar photovoltaic structural panel according to embodiments 24, wherein the at least one perimeter member comprises a GFRP.
26. An integrated, solar photovoltaic structural panel according to any of embodiments 1-25, wherein the panel meets the criteria for a Class II electrical classification.
27. An integrated, solar photovoltaic structural panel according to any of embodiments 1-26, wherein the electrical components that are contained within the panel include one or more components selected from the group consisting of wiring, diodes and overcurrent protectors.
28. An integrated, solar photovoltaic structural panel according to any of embodiments 1-27, wherein the electrical components that are contained within the panel further comprise a micro-inverter.
29. An integrated, solar photovoltaic structural panel according to any of embodiments 1-28, wherein the electrical components that are contained within the panel further comprise MPPT circuitry.
30. An integrated, solar photovoltaic structural panel according to any of embodiments 1-29, further comprising diagnostic hardware and/or software that provides a signal when the solar photovoltaic system is working properly, not working properly, or both.
31. An integrated, solar photovoltaic structural panel according to any of embodiments 1-30, wherein the panel provides an electrically insulating barrier for the electrical components.
32. An integrated, solar photovoltaic structural panel according to any of embodiments 1-31, wherein the panel comprises an ARC-resistant enclosure.
33. An integrated, solar photovoltaic structural panel according to any of embodiments 1-32, wherein the support comprises a GFRP that comprises a resin selected from the group consisting of thermoplastic polymers and thermosetting polymers.
34. An integrated, solar photovoltaic structural panel according to any of embodiments 1-33, wherein the top layer is a GFRP that comprises a resin that is comprised of an emulsified epoxy resin and Portland cement blend.
35. An integrated, solar photovoltaic structural panel according to any of embodiments 1-34, wherein the top layer comprises a GFRP that is produced using a wet laminate layup process.
36. An integrated, solar photovoltaic structural panel according to any of embodiments 1-35, wherein the support comprises a foam that is comprised of a foam-in-place polyurethane.
37. An integrated, solar photovoltaic structural panel according to any of embodiments 1-36, wherein the panel is a structural insulated panel (SIP).
38. A process for making an integrated, solar photovoltaic structural panel comprising:
   providing a structural panel comprising:
      top and bottom stress carrying layers and a support there between that provides separation of the top and bottom layers; and
      electrical components for conducting and managing electrical energy, wherein the electrical components are contained within the panel,
   affixing at least one solar photovoltaic collector to the top layer of the panel, by means of an adhesive encapsulant, and
   electrically connecting the at least one solar photovoltaic collector to the electrical components contained within the panel.
39. A process for making an integrated, solar photovoltaic structural panel comprising:
   providing a structural panel comprising:
      a semi-monocoque comprising a core and top and bottom layers, wherein the core comprises a support that carries shear loads and provides separation of the top and bottom structural layers, and
   affixing at least one solar photovoltaic collector to the top layer of the panel, by means of an adhesive-encapsulant and
   electrically connecting the at least one solar photovoltaic collector to the electrical components contained within the panel,
   wherein said semi-monocoque is adapted to form a part of an exterior barrier of a building structure.
40. A process for making an integrated, solar photovoltaic structural panel according to embodiments 38 or 39, wherein the integrated, solar photovoltaic structural panel is adapted to form part of a wall or a roof of a building structure.
41. A process for making an integrated, solar photovoltaic structural panel according to embodiments 38 to 40, further comprising the step of providing an adhesive-encapsulant layer is provided covering the solar absorber.
42. A process for making an integrated, solar photovoltaic structural panel according to any of embodiments 38 to 41, further comprising the continuous process step of providing a liquid-applied, adhesive-encapsulating layers that embed the solar absorber therein.
43. A process for making an integrated, solar photovoltaic structural panel according to any of embodiments 38 to 42, further comprising the step of providing a UV protective layer covering the solar absorber.
44. A process for making an integrated, solar photovoltaic structural panel according to any of embodiments 38 to 41, further comprising the step of providing a UV protective layer covering the solar absorber, wherein the UV protective layer comprises a UV protective fluoropolymer.
45. A process for making an integrated, solar photovoltaic structural panel according to any of embodiments 38 to 44, further comprising the step of providing a thermosetting adhesive layer between the top layer and the solar absorber, wherein the thermosetting adhesive layer bonds the solar absorber to the top layer.
46. A process for making an integrated, solar photovoltaic structural panel according to embodiment 45, wherein the thermosetting adhesive is thermally conductive.
47. A process for making an integrated, solar photovoltaic structural panel according to embodiment 46, wherein the thermosetting adhesive comprises a thermally conducting additive.
48. A process for making an integrated, solar photovoltaic structural panel according to embodiment 47, wherein the thermally conducting additive is selected from the group consisting of alumina, boron nitride, zinc sulfide, exfoliated graphite, di-iron phosphide, and combinations thereof.
49. A process for making an integrated, solar photovoltaic structural panel according to any of embodiments 38-48, wherein the stress carrying top layer is a glass fiber reinforced polymer (GFRP).
50. A process for making an integrated, solar photovoltaic structural panel according to embodiments 49, wherein the GFRP comprises a thermally conducting additive.
51. A process for making an integrated, solar photovoltaic structural panel according to 50, wherein the thermally conducting additive in the GFRP selected from the group consisting of alumina, boron nitride, zinc sulfide, exfoliated graphite, di-iron phosphide, and combinations thereof.
52. A process for making an integrated, solar photovoltaic structural panel according to any of embodiments 38-51, wherein the support comprises a foam.
53. A process for making an integrated, solar photovoltaic structural panel according to any of embodiments 38-52, wherein the panel comprises channels adapted to provide airflow within the panel.
54. A process for making an integrated, solar photovoltaic structural panel according to any of embodiments 38-53, wherein the channels are adapted to provide a chimney effect to provide passive cooling to the panel.
55. A process for making an integrated, solar photovoltaic structural panel according to any of embodiments 38-54, wherein the foam core includes at least one cavity and wherein electrical components are contained within the at least one cavity.
56. A process for making an integrated, solar photovoltaic structural panel according to any of embodiments 38-55, wherein the panel comprises channels adapted to provide airflow within the panel, and wherein the airflow provides cooling to at least one electrical component within the panel.
57. A process for making an integrated, solar photovoltaic structural panel according to any of embodiments 38-56, wherein the panel electrically insulates at least one electrical component within the panel.
58. A process for making an integrated, solar photovoltaic structural panel according to any of embodiments 38-57, wherein all electrical components within the panel are electrically insulated by at least one layer of electrically insulated material.
59. A process for making an integrated, solar photovoltaic structural panel according to any of embodiments 38-58, wherein all electrical components within the panel are electrically insulated by two layers of insulating material.
60. A process for making an integrated, solar photovoltaic structural panel according to any of embodiments 38-59, wherein the bottom layer is a GFRP stressed skin laminate.
61. A process for making an integrated, solar photovoltaic structural panel according to any of embodiments 38-60, wherein the panel comprises at least one perimeter member.
62. A process for making an integrated, solar photovoltaic structural panel according to any of embodiments 38-61, wherein the at least one perimeter member comprises a GFRP.
63. A process for making an integrated, solar photovoltaic structural panel according to any of embodiments 38-62, wherein the panel meets the criteria for a Class II electrical classification.
64. A process for making an integrated, solar photovoltaic structural panel according to any of embodiments 38-64, wherein the electrical components that are contained within the panel include one or more components selected from the group consisting of wiring, diodes and overcurrent protectors.
65. A process for making an integrated, solar photovoltaic structural panel according to any of embodiments 38-64, wherein the electrical components that are contained within the panel further comprise a micro-inverter.
66. A process for making an integrated, solar photovoltaic structural panel according to any of embodiments 38-65, wherein the electrical components that are contained within the panel further comprise MPPT circuitry.
67. A process for making an integrated, solar photovoltaic structural panel according to any of embodiments 38-66, wherein the panel further comprises diagnostic hardware and/or software that provides a signal when the solar photovoltaic system is working properly, not working properly, or both.
68. A process for making an integrated, solar photovoltaic structural panel according to any of embodiments 38-67, wherein the panel provides an electrically insulating barrier for the electrical components.
69. A process for making an integrated, solar photovoltaic structural panel according to any of embodiments 38-68, wherein the panel comprises an ARC-resistant enclosure.
70. A process for making an integrated, solar photovoltaic structural panel according to any of embodiments 38-69, wherein the support comprises a GFRP that comprises a resin selected from the group consisting of thermoplastic polymers and thermosetting polymers.
71. A process for making an integrated, solar photovoltaic structural panel according to any of embodiments 38-70, wherein the top layer is a GFRP that comprises a resin that is comprised of an emulsified epoxy resin and Portland cement blend.
72. A process for making an integrated, solar photovoltaic structural panel according to any of embodiments 38-71, wherein the top layer comprises a GFRP that is produced using a wet laminate layup process.
73. A process for making an integrated, solar photovoltaic structural panel according to any of embodiments 38-72, wherein the support comprises a foam that is comprised of a foam-in-place polyurethane.
74. A process for making an integrated, solar photovoltaic structural panel according to any of embodiments 38-73, wherein the panel is a structural insulated panel (SIP).
75. A process for making an integrated, solar photovoltaic structural panel according to any of embodiments 38-74, wherein the process is a continuous process.
76. A process for making an integrated, solar photovoltaic structural panel according to any of embodiments 38-75, wherein a fire-resistant, fire-retardant, or fireproof coating is provided to a portion of the panel.
77. A process for making an integrated, solar photovoltaic structural panel according to any of embodiments 38-76, wherein the coating is char-forming.
78. A process for making an integrated, solar photovoltaic structural panel according to embodiment 77, wherein the char-forming intumescent coating is Jotachar JF750.
79. A process for making an integrated, solar photovoltaic structural panel according to any of embodiments 38-78, wherein the top layer comprises a GFRP, wherein the binder polymer is a phenolic resin that imparts a fire resistant property.
80. An integrated, solar photovoltaic structural panel according to any of embodiments 1-37, wherein a fire-resistant, fire-retardant, or fireproof coating is provided to a portion of the panel.
81. An integrated, solar photovoltaic structural panel according to embodiment 80, wherein the coating is char-forming.
82. An integrated, solar photovoltaic structural panel according to embodiment 81, wherein the char-forming intumescent coating is Jotachar JF750.
83. An integrated, solar photovoltaic structural panel according to embodiment 80, wherein the top layer comprises a GFRP, wherein the binder polymer is a phenolic resin that imparts a fire resistant property.
84. A process for providing heated air to a location, comprising the steps of providing an integrated solar photovoltaic structural panel according to embodiments 16 or 17, and providing heated air from the channels to the location.

One of ordinary skill in the art will recognize that there could be variations to the embodiments described and illustrated in this disclosure and that those variations would be within the spirit and scope of the inventions described herein. Accordingly, many modifications may be made by one of ordinary skill in the art without departing from the spirit and scope of the appended claims.

1. An integrated, solar photovoltaic structural panel, comprising:
a panel comprising top and bottom stressed skin layers and a support there between that provides separation of the top and bottom layers, and
a solar photovoltaic system that is integral with the panel, wherein the solar photovoltaic system comprises:
a solar absorber affixed to the top layer of the panel; and
electrical components for conducting and managing electrical energy, wherein the electrical components are contained between the top and bottom layers.

2.-10. (canceled)

11. A process for making an integrated, solar photovoltaic structural panel comprising:
providing a structural panel comprising:
top and bottom stress carrying layers and a support there between that provides separation of the top and bottom layers; and
electrical components for conducting and managing electrical energy, wherein the electrical components are contained within the panel,
affixing at least one solar photovoltaic collector to the top layer of the panel, by means of an adhesive encapsulant, and
electrically connecting the at least one solar photovoltaic collector to the electrical components contained within the panel.

12.-15. (canceled)
